(19) United States
(12) Patent Application Publication
(10) Pub. No.: US 2026/0043473 A1
(43) Pub. Date: Feb. 12, 2026

(54) PARKING LOCK CLUTCH

(71) Applicant: TSUBAKIMOTO CHAIN CO., Osaka (JP)

(72) Inventor: Tsubasa Sugiya, Osaka (JP)

(73) Assignee: TSUBAKIMOTO CHAIN CO., Osaka (JP)

(21) Appl. No.: 19/283,594

(22) Filed: Jul. 29, 2025

(30) Foreign Application Priority Data
Aug. 7, 2024 (JP) 2024-131098

(51) Int. Cl. F16H 63/34; F16H 59/10

(52) U.S. Cl. CPC F16H 63/3425; F16H 59/10

(57) ABSTRACT

Provided is a parking lock clutch that can increase the degree of freedom in controlling the rotational position of a selector with a simple structure, and can implement miniaturization, reduced manufacturing costs, and a longer life. A selector 140 configured to switch an operating mode between a lock mode and a free mode has a pocket 143 configured to accommodate a roller 130 in a roller accommodating portion 117 provided on one of the outer ring 110 and the inner ring 120. The pocket 143 is formed to extend in a circumferential direction so that the selector 140 can be rotated further in an unlocking direction from the rotational angle position at which the roller 130 is accommodated in the roller accommodating portion 117.

### BACKGROUND OF THE INVENTION

### 1. Field of the Invention

The present invention relates to, for example, a parking lock clutch suitable for use in constructing a parking lock system for vehicles.

### 2. Description of the Related Art

A parking lock system for vehicles is known in which a plurality of selectable one-way clutches or a plurality of two-way clutches are interposed between each of a plurality of shift gear trains and an input shaft, or between each of a plurality of shift gear trains and an output shaft, respectively, and a parking lock that prohibits rotation of the output shaft is established by placing two systems of shift gear trains, which have different gear ratios, in a double mesh state (see, for example, Japanese Patent Application Publication No. 2022-049749).

In the parking lock system for vehicles described in Japanese Patent Application Publication No. 2022-049749, in order to establish a parking lock mechanism, the operating mode of the selectable clutches is controlled so that the plurality of selectable clutches are in a double mesh state, and this not only requires complex control but also increases the number of parts.

To address these problems, the present applicant has proposed a roller ratchet type selectable clutch suitable for constructing a parking lock system for vehicles.

This selectable clutch is configured to be able to implement switching between a lock mode, which prohibits relative rotation between the outer and inner rings, and a free mode, which allows relative rotation between the outer and inner rings, by rotating the selector within a specified angle range. The selector is configured to move rollers radially by rotating the selector so that in the lock mode, the rollers are supported by roller support grooves provided on one of the outer and inner rings, and in the free mode, the rollers are accommodated in roller accommodating portions provided on the other of the outer and inner rings.

Meanwhile, in an automatic transmission, shift ranges including P-range, R-range, N-range, and D-range are set, and the shift ranges can be switched over by operating a shift lever provided inside the vehicle cabin.

As a method for linking the operation of the shift lever with the switching of the gear range, a mechanical link mechanism that transmits the operation of the shift lever to the automatic transmission via a shift cable is known (see, for example, Japanese Patent Application Publication No. 2011-084187).

### SUMMARY OF THE INVENTION

Accordingly, in the above-mentioned roller ratchet type selectable clutch, the rotational angle position of the selector can be controlled only between the position in the lock mode, in which the roller is supported by the roller support groove, and the position in the free mode, in which the roller is accommodated in the roller accommodating portion. Therefore, since the degree of freedom of rotation of the selector is limited, when the selectable clutch is applied to a parking lock system, it is necessary to perform electronic control by active control.

On the other hand, in a configuration in which the shift lever and automatic transmission are connected by a shift cable, the selector cannot be rotated in response to the operation of the shift lever. Therefore, there is a problem in that the above-mentioned selectable clutch cannot be applied to a configuration in which the operation of the shift lever and the switching of the gear range are connected by a mechanical link mechanism.

The present invention has been made based on the above circumstances, and an object thereof is to provide a parking lock clutch that has a simple structure, is capable of increasing the degree of freedom in controlling the rotational position of the selector, and is capable of implementing miniaturization, reduced manufacturing costs, and a longer life.

The present invention solves the above-mentioned problems by providing a parking lock clutch including: an outer ring and an inner ring arranged coaxially so as to be rotatable relative to each other; a plurality of rollers arranged between the outer ring and the inner ring; a biasing member radially biasing the roller toward a roller accommodating portion provided on one of the outer ring and the inner ring; and a selector arranged rotatably independent of the outer ring and the inner ring, wherein the selector is configured to switch an operating mode between a lock mode, in which the relative rotation of the outer ring and the inner ring is prohibited by sandwiching the roller in a circumferential direction between the roller accommodating portion and a roller support groove provided on the other of the outer ring and the inner ring, and a free mode, in which the relative rotation of the outer ring and the inner ring is permitted by accommodating the roller in the roller accommodating portion, the selector has a pocket formed so that the roller can be accommodated in the roller accommodating portion when the operating mode is switched to the free mode, and the pocket is formed to extend in the circumferential direction so that the selector can be rotated further in an unlocking direction of the selector from a rotational angle position at which the roller is accommodated in the roller accommodating portion.

According to the present invention, the operating mode can be switched between the lock mode and the free mode by a simple switching operation of controlling the position of the roller by rotating the selector, so that a parking lock can be realized with a simple configuration without requiring complex control.

In addition, the biasing member is provided to bias the roller toward the roller accommodating portion, and the relative rotation of the outer and inner rings is prohibited by the selector receiving the load acting on the roller toward the roller accommodating portion when the roller is sandwiched between the roller support groove and the roller accommodating portion. Due to this, it is possible to easily rotate the selector with a small force (release force) even if torque remains when switching the operating mode from the lock mode to the free mode. Due to this, it is possible to extend the life without damaging the roller and the outer and inner rings. Moreover, when a drive source such as an actuator is used to rotate the selector, the drive source itself can be made smaller, making it possible to reduce the size and the manufacturing costs of the parking lock clutch.

Moreover, since the selector has the pocket formed so that the selector can be rotated further in the unlocking direction from the rotational angle position where the roller is accommodated in the roller accommodating portion, the movable range of the selector can be expanded, and the degree of freedom in controlling the rotational position of the selector can be increased.

Also, by configuring the pocket so that the rotational angle position of the selector can be switched in multiple stages, the degree of freedom in controlling the rotation position of the selector can be further improved. Due to this, it is possible to apply the parking lock clutch, for example, to a mechanism in which the shift operation of the shift lever is transmitted to the transmission via a shift cable.

Furthermore, the recess is formed on the inner or outer circumferential surface of the selector to form the pocket, and a wall surface on the locking direction side of the recess is configured as an inclined surface configured to guide the roller into the roller support groove by the rotation of the selector in the locking direction. Therefore, when the selector is rotated in the locking direction, the roller accommodated in the roller accommodating portion can be easily moved radially toward the roller support groove by the action of the inclined surface of the pocket. Due to this, it is possible to easily switch from the free mode to the lock mode and to achieve reliable locking.

Furthermore, the parking lock clutch includes a selector drive mechanism including a drive rod connected to the selector and capable of reciprocating in one direction, and a standby spring that is provided so as to be elastically deformable in a compression direction when the selector is rotated in the locking direction. Therefore, if the phase alignment between the roller accommodating portion and the roller support groove is not achieved when the operating mode is switched from the free mode to the lock mode, the standby spring is compressed to prevent rotation of the selector. Due to this, the parking lock clutch can be maintained in a locked standby state, and once the phase alignment between the roller accommodating portion and the roller support groove is achieved, the biasing force of the standby spring is released, thereby allowing the selector to rotate and be locked. As a result, it is possible to reliably prevent chipping or damage caused by impact due to sudden meshing, extend the life, and ensure high safety.

Furthermore, the selector is configured to be connectable to a shift cable, the selector is positioned in a first position that sets the operating mode of the parking lock clutch to the lock mode when the shift lever is positioned in the P-range, and the rotational angle position of the selector can be controlled in response to the operation of the shift lever. Thus, the selector can be controlled in response to the operation of the shift cable. Therefore, it is possible to cover the shift ranges including the P-range, R-range, N-range, D-range, and L-range in the transmission and perform a smooth switching operation. In addition, by appropriately changing the mounting position of the shift cable relative to the selector, the cable operating range on the vehicle side can be easily adjusted.

### BRIEF DESCRIPTION OF THE DRAWINGS

FIG. 1 is a perspective view showing the configuration of a parking lock clutch according to one embodiment of the present invention;

FIG. 2 is a plan view as seen from one axial end side, with part of the parking lock clutch shown in FIG. 1 omitted;

FIG. 3 is a cross-sectional view along line A-A in FIG. 2;

FIG. 4 is a perspective view showing the configuration of an outer ring in the parking lock clutch shown in FIG. 1;

FIG. 5 is a perspective view showing the configuration of a selector in the parking lock clutch shown in FIG. 1;

FIG. 6 is a schematic diagram showing a state in which the outer ring and the inner ring mesh each other;

FIG. 7 is a plan view as seen from one axial end side, with part of the parking lock clutch omitted, when the selector is positioned in the second position and the operating mode is in the free mode;

FIG. 8 is a plan view as seen from one axial end side, with part of the parking lock clutch omitted, when the selector is positioned in the third position and the operating mode is in the free mode;

FIG. 9 is a plan view as seen from one axial end side, with part of the parking lock clutch omitted, when the parking lock clutch shown in FIG. 1 is in a lock standby state; and

FIG. 10 is a schematic diagram showing an example of the configuration of a parking lock system.

### DESCRIPTION OF THE PREFERRED EMBODIMENTS

Below, a parking lock clutch according to one embodiment of the present invention will be described with reference to the drawings.

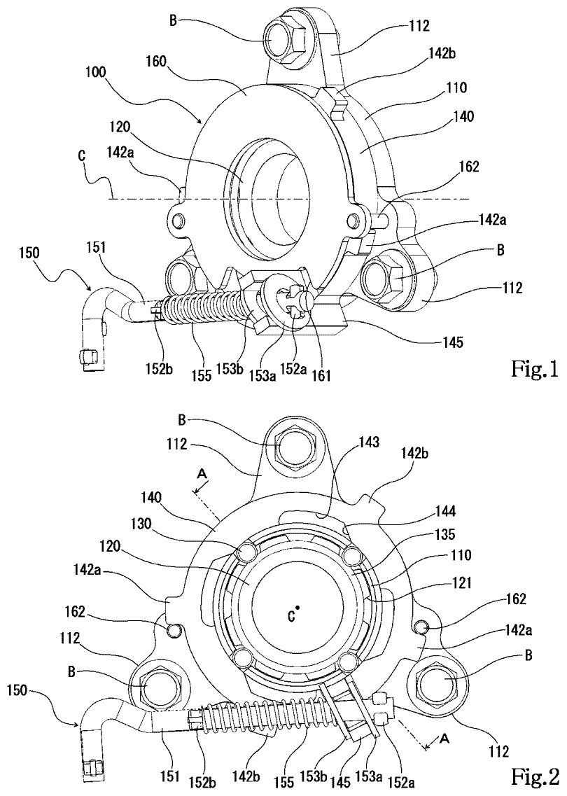

As shown in FIGS. 1 to 3, a parking lock clutch 100 according to the present embodiment includes an outer ring 110, an inner ring 120, a plurality of rollers 130, a biasing member 135, a selector 140, a selector drive mechanism 150, and a retaining plate 160. C in FIGS. 1 to 3 indicates the rotation axis.

The outer ring 110 and the inner ring 120 are arranged coaxially so as to be rotatable relative to each other so that the inner circumferential surface of the outer ring 110 and the outer circumferential surface of the inner ring 120 face each other at close proximity. In the present embodiment, the outer ring 110 is fixed and the inner ring 120 is configured to rotate.

As shown in FIG. 4, the outer ring 110 has an annular plate-shaped base portion 111 and a cylindrical portion 115 extending from an inner circumferential edge on one surface of the base portion 111 toward one axial end side.

Notches extending in the axial direction from one axial edge are provided at positions arranged at specified intervals in the circumferential direction of the cylindrical portion 115 so that stepped portions 113 are formed in the base portion 111. As a result, a plurality of roller accommodating portions 117 corresponding to the respective rollers 130 are formed so as to be able to accommodate the rollers 130.

Mounting portions 112 are provided on the outer circumferential surface of the base portion 111 at positions arranged at specified intervals in the circumferential direction, and are configured to be fixed to a mounting target object, for example, by fixing bolts B (see FIG. 1).

In addition, an annular stepped portion 116 is formed on the inner circumferential edge on one end side of the cylindrical portion 115, and the biasing member 135 is positioned when the roller 130 is accommodated in the roller accommodating portion 117.

The inner ring 120 is configured by forming, on the outer circumferential surface of a cylindrical base material, a plurality of roller support grooves 121 extending in the axial direction at specified intervals in the circumferential direction and capable of accommodating and supporting a part of the circumferential surface of the roller 130.

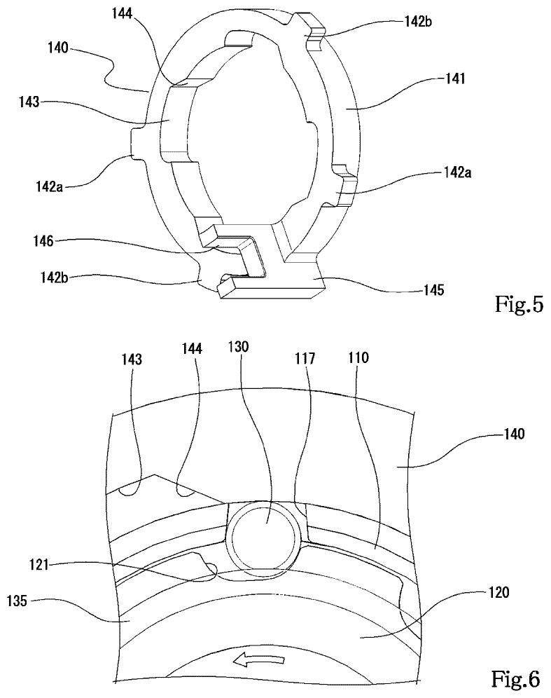

The roller support groove 121 is configured as a concave groove having a substantially flat bottom wall portion and circumferential wall portions having an arcuate cross-sectional shape continuous with both sides of the bottom wall portion (see FIG. 6). In the present embodiment, the opening edge portion of the roller support groove 121 has a C-chamfered shape, so that even if the roller 130 tries to move toward the roller support groove 121 side due to an erroneous operation or malfunction of the selector 140 when the inner ring 120 is rotating at a certain rotation speed or higher, the roller 130 is repelled toward the roller accommodating portion 117 side by the chamfered portion. Due to this, it is possible to prevent the outer ring 110 and the inner ring 120 from meshing with each other, thereby achieving high safety. The opening edge portion of the roller support groove 121 may have an R-chamfered shape, for example.

In the present embodiment, for example, four rollers 130 are arranged at positions spaced at specified intervals in the circumferential direction, but the number of roller support grooves 121 is greater than the number of rollers 130. The number of rollers 130 is not particularly limited, and the arrangement intervals do not necessarily have to be equal.

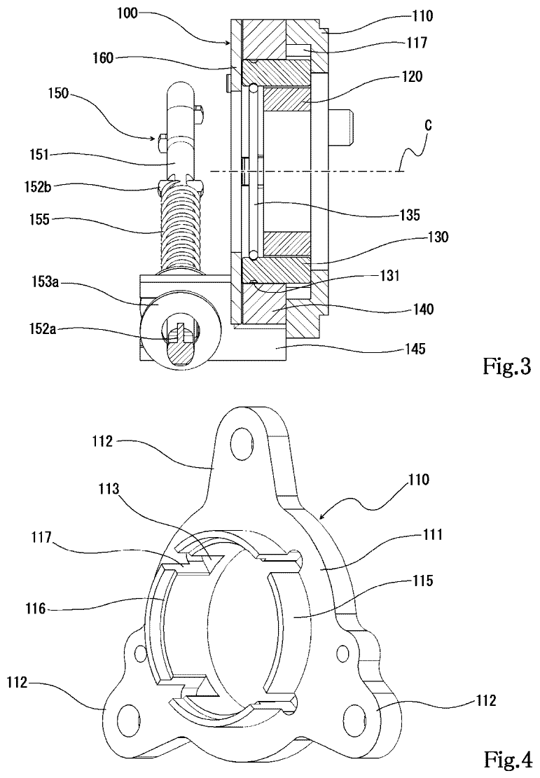

As shown in FIG. 3, each of the rollers 130 is configured to protrude axially outward beyond one end surface of the inner ring 120 while being supported by the roller support groove 121, and a biasing member mounting groove 131 is formed on the circumferential surface of the protruding portion so as to extend over the entire circumference in the circumferential direction.

The movement of each of the rollers 130 toward the other axial end side is restricted by the stepped portion 113 formed on the base portion 111 of the outer ring 110.

In the present embodiment, the biasing member 135 is common to each of the plurality of rollers 130 and is configured, for example, as an annular spring.

The biasing member 135 is mounted on the biasing member mounting groove 131 of the roller 130 from the radially inner side so as to bias each roller 130 radially outward toward the roller accommodating portion 117.

The selector 140 is arranged coaxially with and rotatable relative to both the outer ring 110 and the inner ring 120, while being axially spaced apart from the outer ring 110 in which the roller accommodating portions 117 are formed.

As shown in FIG. 5, the selector 140 has an annular plate-shaped main body 141, and is configured so that the roller 130 can be pressed by the inner circumferential surface of the main body 141 so that the roller 130 is supported by the roller support groove 121 in a lock mode in which the relative rotation of the outer ring 110 and the inner ring 120 is prohibited.

The inner circumferential surface of the main body 141 is formed with a pocket 143 configured so that the roller 130 can be accommodated in the roller accommodating portion 117 when the selector 140 is rotated in an unlocking direction (for example, clockwise in FIG. 2) to switch to a free mode in which the relative rotation of the outer ring 110 and the inner ring 120 is permitted.

The pocket 143 is configured as a recess extending in the circumferential direction so that the selector 140 can rotate further in the unlocking direction of the selector 140 from the rotational angle position where the roller 130 is accommodated in the roller accommodating portion 117. In this way, the movable range of the selector 140 can be expanded, and the degree of freedom in controlling the rotational position of the selector 140 can be increased.

The pocket 143 is configured so that the rotational angle position of the selector 140 can be switched in multiple stages. In this way, the rotational position of the selector 140 can be controlled at a first position, which is a rotational angle position where the operating mode of the parking lock clutch 100 is set to the lock mode, a second position, which is a rotational angle position where the operating mode of the parking lock clutch 100 is set to the free mode by accommodating the roller 130 in the roller accommodating portion 117, a third position where the roller 130 is located at the end of the pocket 143 in the unlocking direction, and any rotational angle position between the second and third positions.

The wall surface of the pocket 143 on the locking direction side is an inclined surface 144 that inclines radially outward in the unlocking direction. By rotating the selector 140 in the locking direction, the roller 130 accommodated in the roller accommodating portion 117 can be easily moved radially toward the roller support groove 121 by the action of the inclined surface 144 of the pocket 143. Due to this, it is possible to easily switch from the free mode to the lock mode and to realize a reliable lock.

In addition, on the outer circumferential surface of the main body 141, a pair of locking direction rotation restricting protrusions 142a are formed at positions facing each other with the rotation axis C interposed therebetween and a pair of unlocking direction rotation restricting protrusions 142b are formed at positions facing each other with the rotation axis C interposed therebetween.

The selector 140 has a selector arm 145 that is connected to the selector drive mechanism 150. In the present embodiment, the selector arm 145 is configured as a plate-shaped body extending along a plane along the rotation axis C, and is provided, for example, at a position between the locking direction rotation restricting protrusion 142a and the unlocking direction rotation restricting protrusion 142b in the circumferential direction. The selector arm 145 has a notch 146 formed at one axial end to allow insertion of a drive rod 151, and one end of the selector arm 145 has a U-shaped configuration.

As shown in FIG. 2, the selector drive mechanism 150 includes the drive rod 151 that has one end connected to the selector arm 145 and can reciprocate in one direction (left-right direction in FIG. 2) so that the selector 140 can be positioned within a range between the first position and the third position, and a standby spring 155 that is arranged so that it can be elastically deformed in the compression direction when the drive rod 151 is moved so that the selector 140 rotates in the unlocking direction. In the present embodiment, the standby spring 155 is configured as a coil spring, and the drive rod 151 is inserted through the standby spring 155.

The drive rod 151 is connected to the selector arm 145 in such a way that a pair of retaining rings 153a and 153b are provided on the drive rod 151 so as to sandwich the selector arm 145, one retaining ring 153a is engaged with a tip-side engagement portion 152a of the drive rod 151, and the other retaining ring 153b is brought into contact with the selector arm 145 in a pressed state by the standby spring 155. The other end of the standby spring 155 is engaged with a base end-side engagement portion 152b of the drive rod 151.

The retaining plate 160 has an annular plate shape and, as shown in FIG. 1, is positioned coaxially with the outer ring 110 and the inner ring 120 at one axial end side of the selector 140 and is fixed to the mounting portion 112 of the outer ring 110 by a pin member 162. In this way, the components of the parking lock clutch 100 are prevented from becoming displaced in the axial direction. As shown in FIG. 3, the retaining plate 160 is disposed so as to cover the roller support groove 121, and also functions as a retainer for the roller 130.

As shown in FIG. 1, a notch 161 is formed on the outer circumferential surface of the retaining plate 160 so as to extend in the circumferential direction, and the selector arm 145 is positioned in the notch 161.

The pin member 162 is provided at a position where the locking direction rotation restricting protrusion 142a and the unlocking direction rotation restricting protrusion 142b of the selector 140 can engage with the pin member 162. Therefore, the locking direction rotation restricting protrusion 142a or the unlocking direction rotation restricting protrusion 142b engage with the pin member 162, thereby restricting the movable range of the selector 140. Due to this, it is possible to prevent overrunning of the selector 140, and ensure that switching between the free mode and the lock mode can be performed.

In the parking lock clutch 100, as seen from one axial end side, when the locking direction rotation restricting protrusion 142a is positioned at the first position where it engages with the pin member 162, the roller 130 is pressed by the inner circumferential surface of the selector 140 against the biasing force of the biasing member 135 and is supported by the roller support groove 121 of the inner ring 120, as shown in FIGS. 1 to 3. That is, the operating mode of the parking lock clutch 100 is set to a lock mode in which the relative rotation of the outer ring 110 and the inner ring 120 is prohibited.

In the lock mode, as shown in FIG. 6, when a rotational torque is input to the inner ring 120, the roller 130 is sandwiched between the roller support groove 121 and the roller accommodating portion 117 of the outer ring 110, regardless of the rotation direction of the inner ring 120. Furthermore, the load acting at this time in the direction of moving the roller 130 toward the roller accommodating portion 117 is supported by the selector 140, so that the outer ring 110 and the inner ring 120 mesh with each other. FIG. 6 shows the state when the inner ring 120 is rotated in the locking direction (counterclockwise).

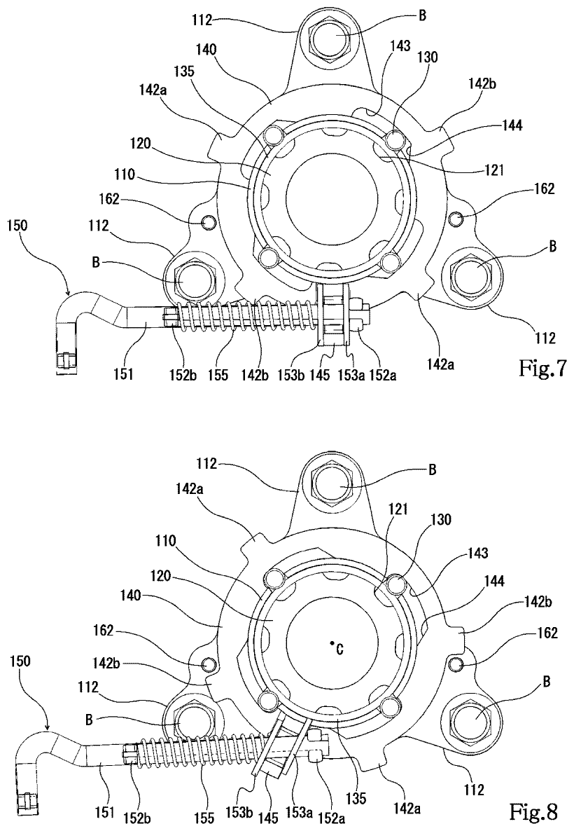

When the selector 140 is rotated in the unlocking direction (clockwise in FIG. 2) and positioned at the second position, as shown in FIG. 7, the roller 130 is moved radially outward and accommodated in the roller accommodating portion 117 of the outer ring 110 by the load acting on the roller 130 in the direction toward the roller accommodating portion 117 and the biasing force of the biasing member 135. In other words, the operating mode of the parking lock clutch 100 is switched to a free mode in which the relative rotation of the outer ring 110 and the inner ring 120 is permitted.

Accordingly, in the parking lock clutch 100 described above, the selector 140 can be further rotated in the unlocking direction from the second position, and the rotation of the selector 140 is restricted by the engagement of the unlocking direction rotation restricting protrusion 142b with the pin member 162. FIG. 8 shows a state in which the selector 140 is rotated to be positioned at the third position, which is the limit position in the unlocking direction.

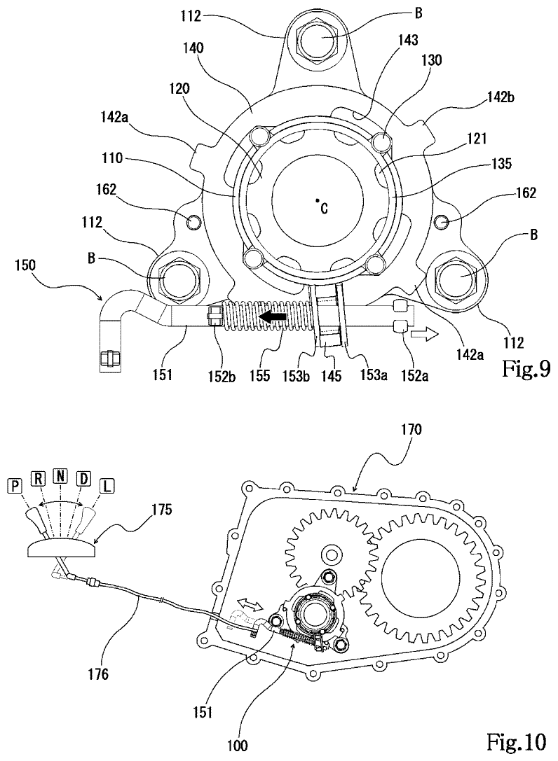

On the other hand, when the selector 140 is rotated in the locking direction to the second position to switch the operating mode of the parking lock clutch 100 from the free mode to the lock mode, if the phase alignment between the roller accommodating portion 117 of the outer ring 110 and the roller support groove 121 of the inner ring 120 is not achieved, as shown in FIG. 9, the rotation of the selector 140 is prevented, while the drive rod 151 is moved and the standby spring 155 is compressed. At this time, the parking lock clutch 100 is in a lock standby state. As a result, when the inner ring 120 is rotating at a certain rotation speed or higher, chipping or damage caused by impact due to sudden meshing between the outer ring 110 and the inner ring 120 can be reliably prevented, making it possible to extend the life and ensure high safety.

When the phase alignment between the roller accommodating portion 117 and the roller support groove 121 is not achieved, the biasing force of the standby spring 155 is released and the selector 140 rotates in the locking direction to be positioned at the first position. As a result, the roller 130 moves radially toward the roller support groove 121 due to the action of the inclined surface 144 of the pocket 143, and the operating mode of the parking lock clutch 100 is set to the lock mode. At this time, the movable range of the selector 140 is restricted, making it possible to prevent the selector 140 from overrunning and reliably switch between the free mode and the lock mode.

Accordingly, the parking lock clutch 100 described above has the pocket 143 formed so that the selector 140 can rotate further in the unlocking direction of the selector 140 from the second position, which is the rotational angle position where the roller 130 is accommodated in the roller accommodating portion 117. Therefore, it is possible to expand the movable range of the selector 140 and increase the degree of freedom in controlling the rotational position of the selector 140. Therefore, for example, by applying the parking lock clutch to a mechanism in which a shift operation using a shift lever is transmitted to a transmission via a shift cable, it becomes extremely useful in constructing a parking lock system.

FIG. 10 is a schematic diagram showing an example of the configuration of a parking lock system.

In this parking lock system, the inner ring 120 of the parking lock clutch 100 is connected to one of the input shaft, output shaft, and intermediate shaft of an automatic transmission 170, and the drive rod 151 of the selector drive mechanism 150 is connected to a shift lever 175 arranged in the vehicle cabin by a shift cable 176. In the automatic transmission 170, shift ranges including P-range, R-range, N-range, D-range, and L-range are set, and the shift range can be switched by operating the shift lever 175.

In this parking lock system, when the shift lever 175 is positioned in the P-range, the connection state of the shift cable 176 is adjusted so that the selector 140 is positioned in the first position where the operating mode of the parking lock clutch 100 is set to the lock mode.

Therefore, when the shift lever 175 is in the P-range, the parking lock is applied, and it is possible to reliably prevent unintended movement of the vehicle.

In this parking lock system, the rotational angle position of the selector 140 is controlled according to the operation of the shift lever 175, and when the shift lever 175 is positioned in any of the R, N, D, and L-ranges, the operating mode of the parking lock clutch 100 is set to the free mode. Specifically, the selector 140 is in the second position when the shift lever 175 is in the R-range, the selector 140 is in the third position when the shift lever 175 is in the L-range, and the selector 140 is in a rotational angle position between the second and third positions when the shift lever 175 is in the N or D-range. When the shift lever 175 is positioned in any of the R, D, and L-ranges, the vehicle can be started smoothly from a stopped state, and when the shift lever 175 is positioned in the N-range, engine power is not transmitted to the wheels.

Accordingly, the parking lock clutch 100 can control the selector 140 in response to the operation of the shift lever 175, and can cover the shift ranges including the P-range, R-range, N-range, D-range, and L-range in the automatic transmission 170. A parking lock system using the parking lock clutch 100 can therefore smoothly switch the shift ranges, effectively realizing the parking lock.

While the embodiments of the present invention have been described in detail above, the present invention is not limited to the above-described embodiments, and various modifications in design may be made without departing from the scope of the invention as defined in the claims.

For example, in the above embodiment, a configuration in which the roller support groove is formed on the outer circumferential surface of the inner ring, the roller accommodating portion is formed on the inner circumferential surface of the outer ring, and the biasing member is arranged to bias the roller radially outward has been described. However, the roller support groove may be formed on the inner circumferential surface of the outer ring, and the roller accommodating portion may be formed on the outer circumferential surface of the inner ring.

What is claimed is:

1. A parking lock clutch comprising:
an outer ring and an inner ring arranged coaxially so as to be rotatable relative to each other;
a plurality of rollers arranged between the outer ring and the inner ring;
a biasing member radially biasing the roller toward a roller accommodating portion provided on one of the outer ring and the inner ring; and
a selector arranged rotatably independent of the outer ring and the inner ring, wherein
the selector is configured to switch an operating mode between a lock mode, in which the relative rotation of the outer ring and the inner ring is prohibited by sandwiching the roller in a circumferential direction between the roller accommodating portion and a roller support groove provided on the other of the outer ring and the inner ring, and a free mode, in which the relative rotation of the outer ring and the inner ring is permitted by accommodating the roller in the roller accommodating portion,
the selector has a pocket formed so that the roller can be accommodated in the roller accommodating portion when the operating mode is switched to the free mode, and
the pocket is formed to extend in the circumferential direction so that the selector can be rotated further in an unlocking direction of the selector from a rotational angle position at which the roller is accommodated in the roller accommodating portion.

2. The parking lock clutch according to claim 1, wherein the pocket is configured so that the rotational angle position of the selector can be switched in multiple stages.

3. The parking lock clutch according to claim 1, wherein
the pocket is configured as a recess formed on an inner circumferential surface or an outer circumferential surface of the selector, and
a wall surface on a locking direction side of the recess is configured as an inclined surface configured to guide the roller into the roller support groove by the rotation of the selector in the locking direction.

4. The parking lock clutch according to claim 1, further comprising a selector drive mechanism for rotating the selector, wherein
the selector drive mechanism comprises a drive rod connected to the selector and capable of reciprocating in one direction, and a standby spring provided so as to be elastically deformable in a compression direction when the selector is rotated in the locking direction.

5. The parking lock clutch according to claim 1, wherein
the selector is configured to be connectable to a shift cable for mechanically connecting a shift lever and a transmission in a vehicle,
the selector is positioned in a first position that sets the operating mode of the parking lock clutch to the lock mode when the shift lever is positioned in a P-range, and
the rotational angle position of the selector is controlled in response to an operation of the shift lever.
